(19) United States
(12) Patent Application Publication
(10) Pub. No.: US 2015/0371314 A1
(43) Pub. Date: Dec. 24, 2015

(54) METHOD FOR PROVIDING E-COMMERCE SERVICE TO PHYSICAL COMMUNITY

(71) Applicant: RICHPLAY INFORMATION CO., LTD., NEW TAIPEI CITY 22068 (TW)

(72) Inventors: CHI-HSIN LIANG, NEW TAIPEI CITY 22068 (TW); YI-HSIANG CHEN, NEW TAIPEI CITY 22068 (TW)

(21) Appl. No.: 14/741,745

(22) Filed: Jun. 17, 2015

(30) Foreign Application Priority Data
Jun. 23, 2014 (TW) 103121579

(51) Int. Cl. G06Q 30/06

(52) U.S. Cl. CPC G06Q 30/0633

(57) ABSTRACT

The present invention discloses a method for providing e-commerce service to a physical community. When a client device connects to a server providing the e-commerce service, the server determines whether the client device is permitted to register a client account according to if the address information acquired from the client device is located at a physical community. After registration of client account, the client device can log in the server using the client account and order a product or service from the server. Then the product or service is delivered to the address information. By limiting the e-commerce service to the residents of the physical community, the suppliers of products or services, the residents of the physical community, and the third party matching the both sides and providing the e-commerce service all benefit.

### FIELD OF THE INVENTION

The present invention relates generally to a method for providing e-commerce service to a physical community, and particularly to restricting registered members to residents of a physical community and facilitating a win-win situation by reinforcing consumers' bargain power with suppliers by using the purchasing potential of the physical community, endowing suppliers with stable customer bases, as well as reducing costs of customer service and supplying for products.

### BACKGROUND OF THE INVENTION

In recent years, as computer equipment and the Internet become popular gradually, a novel business model, the e-commerce, has been developing prosperously. The two parties of buyers and sellers need not to come face to face before they can do various business activities. Instead, business activities can be carries out using the Internet as the medium, substantially relieving the restrictions by location and time on transactions. Nowadays, consumers can order products or services through the online shopping platforms built by suppliers or third parties. Then the suppliers and logistic companies will distribute the products. Thereby, consumers can complete the whole purchasing process at home. Accordingly, the convenience of the e-commerce stimulates consumers' purchasing desire and impulse insidiously and creates considerable business opportunities.

The e-commerce market in Taiwan has started to grow rapidly since 2005. The annual transaction has exceeded 430 billion NT dollars in 2011. This wave of e-commerce provides a sufficient base for driving many emerging network-native companies. Many shops or brands owning physical channels also try to generate new profit via network platforms and begin network marketing aggressively. Nonetheless, it is relatively difficult for new online shopping platforms to survive in the online shopping market. For consumers already accustomed to ordering products or services to specific online shopping platforms, they normally have little willingness of registering additionally as members of other online shopping platforms. As a consequence, new online shopping platforms usually face the challenge of under-expected amount of registered members as well as the competitive disadvantage of a low proportion of members having had actual transactions.

In order to solve the problem of insufficient members and inferior transaction performance occurring in general online shopping platforms, the present invention provides a method for providing e-commerce to physical community. For general online shopping platforms, their members registered through the Internet come from various locations. On the contrary, the membership of the e-commerce service platform according to the present invention is restricted to the residents of a specific physical community. The stronger linkage between member accounts and member identities facilitates marketing of products or services by suppliers. In addition, all the members live in a specific physical community. Given the extremely dense distribution, the costs for distributing products and delivering services from the suppliers can be reduced.

Furthermore, according to the present invention, the distributed purchasing potentials from individual residents can be grouped in the unit of a physical community, enabling the residents as a whole to form a group with stronger bargain power. By using the advantage, more favorable price offerings can be urged from the suppliers; additional feedback sponsorship to the community can be committed by the suppliers as well. Overall, the present invention matches the customer group of the residents in a physical community with the suppliers of products or services through building an e-commerce service platform for the members registered from the residents of a specific physical community. By reducing the trading costs, the profit margin of both parties can be improved, and thus creating a win-win situation for both sides.

### SUMMARY

An objective of the present invention is to provide a method for providing e-commerce service to a physical community. By restricting the registered members of the e-commerce service platform to the residents of a specific physical community, the operator of the e-commerce service platform acquires a customer group with a stronger linkage between client accounts and identities and with a preferential purchasing potential. Then the platform profits by matching the customer group with the suppliers of products or services.

Another objective of the present invention is to provide a method for providing e-commerce service to a physical community. By restricting the registered members of the e-commerce service platform to the residents of a specific physical community, the suppliers of the products or services of the e-commerce service platform can master the customer group more efficiently for promoting sales of the products or services. In addition, because the members are all concentrated in a physical community, the costs of distributing products and delivering services by the suppliers can be reduced.

Still another objective of the present invention is to provide a method for providing e-commerce service to a physical community. By restricting the registered members of the e-commerce service platform to the residents of a specific physical community, the purchasing potentials of individual residents can be integrated to a group, and thus gaining stronger bargain power for urging favorable prices or feedbacks from the operator of the e-commerce service platform or the suppliers.

In order to achieve the objectives and efficacies as described above, the present invention discloses a method for providing e-commerce service to a physical community. Build an e-commerce service platform in a server and restrict the registration of members of the e-commerce service platform to the residents of a community. When a client device is connected to the server, the server acquires network address information from the client device. By judging if the address information is located at the physical community, whether the client device can register a client account in the server can be decided. After the client device logs in the server using the client account, a product or a service can be ordered from the server. Next, the supplier providing the product or service can deliver the product or service to the location indicated by the address information.

### BRIEF DESCRIPTION OF THE DRAWINGS

FIG. 1A shows a flowchart according to the first embodiment of the present invention;

FIG. 1B shows a schematic diagram of the device connection according to the first embodiment of the present invention;

FIG. 2 shows a schematic diagram of the device connection according to the second embodiment of the present invention;

FIG. 3 shows a schematic diagram of the device connection according to the third embodiment of the present invention;

FIG. 4A shows a flowchart according to the fourth embodiment of the present invention;

FIG. 4B shows a schematic diagram of the device connection according to the fourth embodiment of the present invention;

FIG. 5A shows a flowchart according to the fifth embodiment of the present invention; and

FIG. 5B shows a schematic diagram of the device connection according to the fifth embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a method for providing e-commerce service to a physical community. By verifying using the address information as the main information and supplemented by other information, the registration of membership of the e-commerce service platform is restricted to the residents of a specific physical community. The third party who constructs the platform can thus master the customer group formed by the residents of the physical community and match suppliers with the customer group fro providing products or services. The customer group formed by the residents of the physical community can reduce the costs of the suppliers on the marketing and distribution of products or services. In addition, the bargain power of the customer group can be enhanced for urging for more favorable price offerings or feedbacks. Accordingly, the trading costs of both parties can be lowered.

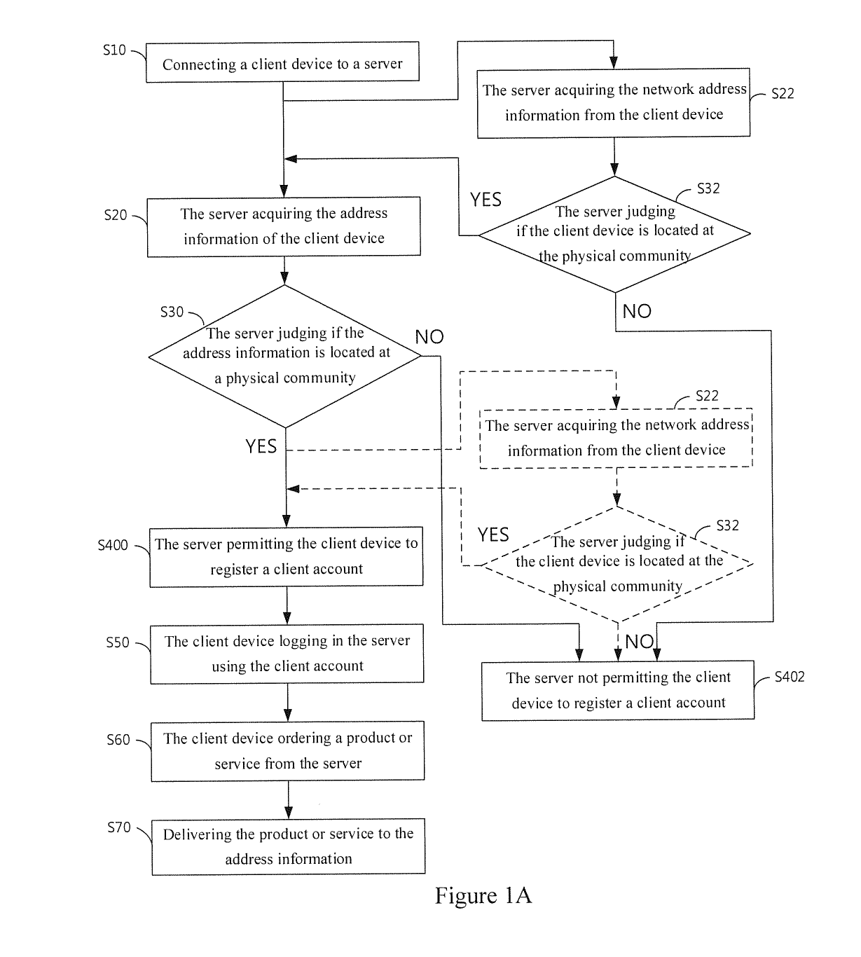

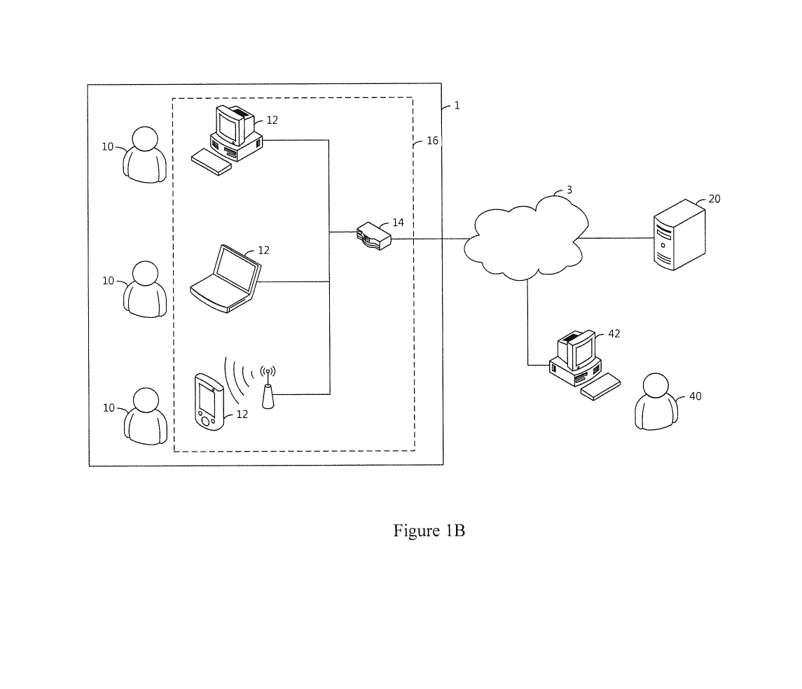

Please refer to FIG. 1A and FIG. 1B, which show a flowchart and a schematic diagram of the device connection according to the first embodiment of the present invention. As shown in FIG. 1A, the method for providing e-commerce service to a physical community mainly comprises steps of:

Step S10: Connecting a client device to a server;

Step S20: The server acquiring the address information of the client device;

Step S30: The server judging if the address information is located at a physical community;

Step S400: The server permitting the client device to register a client account;

Step S402: The server not permitting the client device to register a client account;

Step S50: The client device logging in the server using the client account;

Step S60: The client device ordering a product or service from the server; and

Step S70: Delivering the product or service to the address information.

As shown in FIG. 1B, a physical community 1 comprises a plurality of residents 10 and a plurality of client devices 12. The plurality of residents 10 can use the plurality of client devices 12, respectively, to connect to a server 20. An e-commerce service platform is constructed in the server 20. According to the present embodiment, the plurality of client devices 12 are connected to a router 14, respectively, and forming a local area network 16. The plurality of client devices 12 in the local area network 16 are connected to the Internet 3 through the router 14, and then to the server 20 outside the local area network 16 through the Internet 3. In addition, as shown in the figure, an external person 40 uses an external device 42 to connect to the Internet 3 and to the server 20 through the Internet 3.

In the step S10, in order to use the e-commerce service provided by the server 20, a resident 10 of the physical community 1 use one of the client devices 112 to connect to the Internet 3 via the router 14 and to the server 20 through the Internet 3. Besides, the external personal 40 also use the external device 42 to connect to the server 20 through the Internet 3.

In the step S20, the server 20 acquires a piece of address information input by the resident 10; the external device 42 acquires another piece of address information input by the external person 40.

In the step S30, the server 30 judges if the plurality pieces of address information are located at the physical community 1. A third party who constructs the e-commerce service platform should have stored a plurality of addresses belonging to the physical community 1 in the server 20 in advance. Then the server 20 can compare and judge the plurality pieces of resident information stored therein with the plurality pieces of resident information transmitted by the client device 12 and the external device 42 for making sure if the resident 10 and the external person 40 live in the physical community 1.

Because the external person 40 does not live in the physical community 1, the address information input via the external device 42 and transmitted to the server 20 by the external person 40 does not agree with any address information stored in the server 20. The server 20 judges that the network address information given by the external device 42 is not located at the physical community 1. Then the step S462 is executed for disallowing the external person 40 to register a client account using the external device 42 to the e-commerce service platform built in the server 20.

Contrarily, because the resident 10 lives in the physical community 1, the address information input via the client device 12 and transmitted to the server 20 by the resident 10 agrees with one of the pieces of address information stored in the server 20. The server 20 judges that the address information given by the client device 12 is located at the physical community 1. Then the step S400 is executed for permitting the resident 10 to register a client account using the client device 12 to the e-commerce service platform built in the server 20.

After the resident 10 registers the client account, the step S50 is executed, in which the resident 10 uses the client device 12 to log in the server 20 with the client account.

In the step S60, the resident 10 uses the client device 12 to enter the e-commerce service platform constructed in the server 20. The resident 10 can thus order a product or service using the client account via the e-commerce service platform.

Afterwards, a supplier providing the product or service can acquire the ordering record of the product or service by the client account, as well as the address information input as the resident 10 registers the client account, for executing the step S70. In the step S70, the supplier delivers the product or service to the location represented by the address information.

By disposing the above devices and executing the steps S10 to S70, the method for providing e-commerce service to a physical community can use the server 20 to judge if the address information given from the client device 12 or the external device 42 is located at the physical community 1 and hence determining permission to the resident 10 or the external person 40 for registering a client account in the server 20 using the client device 12 or the external device 42, and thus restricting client registration of the e-commerce service platform to the plurality of residents 10 of the physical community 1. As described above, after the plurality of residents 10 register as the plurality clients of the e-commerce service platform, a third party providing the e-commerce service platform can match the customer group formed by the plurality of residents with a plurality of suppliers providing a plurality of products or services. The plurality of suppliers can use the third party to master the customer group formed by the plurality of clients for selling products or services. The customer group formed by the plurality of clients can take advantage of the group bargain power to urge favorable price offerings from the plurality of suppliers or ask for sponsorship or feedback to the physical community 1 from the plurality of suppliers.

In addition, because the plurality of residents 10 all concentrated in the physical community 1, the distances among the locations of the pieces of network address information are quite short, and hence reducing the costs of delivering products or delivering services by the suppliers reduced. Moreover, because the overall purchasing potential of the plurality of residents 10 of the physical community 1 is huge, the plurality of suppliers can have the opportunities of making more profits and thus increasing their willingness of providing the plurality of residents 10 of the physical community 1 with more discounts or feedbacks. Consequently, positive interactions between the buyers and sellers can be formed, leading to a win-win situation.

In addition to the address information, according to the present invention, the resident 10 is further asked to provide his personal information such as the name, the identity number via the client device 12 as the basis for the server 20 to judge the resident's identity. Nonetheless, in the modern society of circulating personal information, it might be not appropriate for the server 20 to determine registration permission to a user for a client account via a device. Accordingly, the judgment for the location of the device can be added for further restricting that the client device 12 should be located inside the physical community 1 and thus enhancing confirmation and limitation on the identity of the plurality of clients of the e-commerce service platform.

According to the present embodiment, the client device 12 further acquires a piece of network address information for judging if the client device 12 is located at the physical community 1. As described above, the plurality of client device 12 according to the present embodiment are contained in the local area network 16 and connected to the Internet 3 through the router 14. The router 14 uses a physical Internet Protocol Address (IP address) outside the local area network 16, and assigns the client devices 12 inside the local area network 16 with a plurality of virtual IP addresses. Thereby, the plurality of client device 12 can share the physical IP address when they are connected to the Internet 3 via the router 14.

Please refer again to FIG. 1A. According to the present invention, after the step S10 and before the step S20, the following steps can be further included.

Step S22: The server acquiring the network address information from the client device; and

Step S32: The server judging if the client device is located at the physical community.

In the step S22, the server 20 acquires the plurality pieces of network address information of the client device 12 and the external device 42. When the client device 12 is connected outside the local area network 16, its shares the physical IP address used by the router 14. On the other hand, the external device 42 used another physical IP address.

In the step S32, the server 20 uses the plurality pieces of network address information to judge, respectively, if the client device 12 and the external device 42 are located at the physical community 1. Because the physical IP address used by the router 14 according to the present embodiment is fixed, the physical IP address shared from the router 14 for the client device 12 is also fixed. The server 20 can judge if the client device 12 and the external device 42 are contained in the local area network 16 by comparing the pieces of network address information acquired from the client device 12 and the external device 42 with the physical IP address of the router 14. Then whether the client device 12 and the external device 42 are located at the physical community 1 can be inferred.

Because the client device 12 is contained in the local area network 16, the network address information acquired from the client device 12 by the server 20 matches the physical IP address of the router 14. The server 20 judges that the client device 12 is located at the physical community 1. Then the following step S20 is executed, in which the client device 12 acquires the address information and judges if the client 10 is permitted to register the client account in the server 20 using the client device 12.

On the contrary, because the external device 42 is not contained in the local area network 16, the network address information acquired from the client device 12 by the server 20 does not match the physical IP address of the router 14. The server 20 judges that the client device 12 is not located at the physical community 1. Then the step S402 is executed, in which the external person 40 is not permitted to register a client account in the server 20 using the external device 42.

By further executing the steps S22 and S32, according to the method for providing e-commerce service to a physical community of the present invention, the server 20 can judge if the client device 12 or the external device 42 is located at the physical community 1 according to the plurality pieces of network address information by which the client device 12 or the external device 42 connects to the server 20. Then the address of the physical community 1 can be used as the address information. In addition, the plurality pieces of network address information can be further used as the basis by which the server 20 determines if the client device 12 or the external device 42 is allowed to register a client account in the server 20. Accordingly, the purpose of limiting a plurality of registered clients of the e-commerce server platform to the plurality of residents 10 of the physical community 1 can be achieved more perfectly.

Besides, the steps S22 and S32 can be moved between the step S30 and the step S400. Because the address information of the client device 12 has been confirmed in the steps S20 to S30, after the server 20 judges that the client device 12 is located at the physical community 1, the step S400 is executed, in which the resident 10 is permitted to register the client account in the server 20 using the client device 12. If the external person 40 uses the external device 42 and assumes resident information of the physical community 1 for passing the confirmation of the step S30, the server 20 still can judge that the external device 42 is not located at the physical community 1 in the step S32. Then the step S402 is executed for not permitting the external person 40 to register a client account in the server 20 using the external device 42.

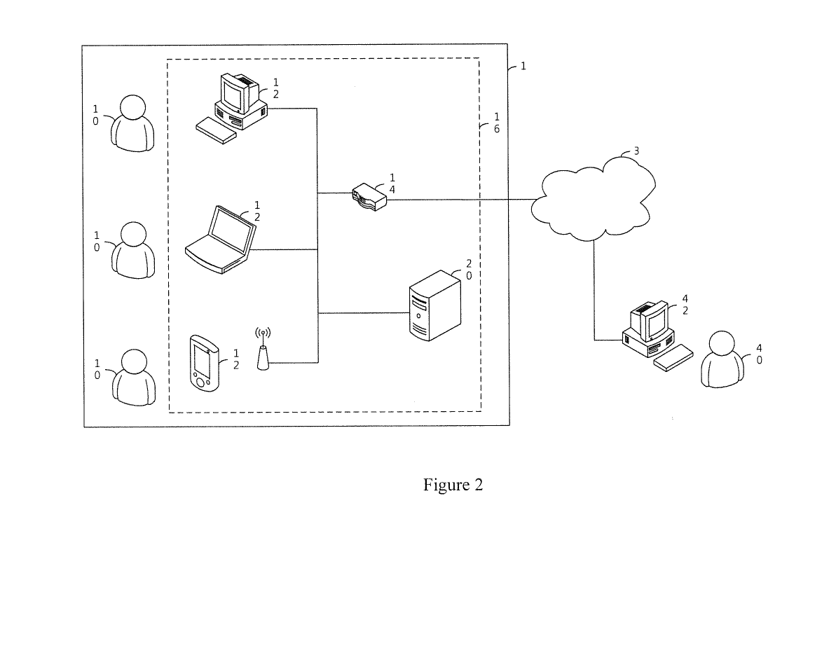

In addition to FIG. 1A, please also refer to FIG. 2, which shows a schematic diagram of the device connection according to the second embodiment of the present invention. As shown in the figure, the main difference between the present embodiment and the first one is that the server 20 providing the e-commerce service is also contained in the local area network 16 and can be connected to the Internet 3 through the router 14. As described above, the router 14 assigns a plurality of virtual IP addresses to the plurality of client devices 12. The server 20 and the plurality of client devices 12 contained in the same local area network 16 can thus identify one another via the plurality of virtual IP addresses. Accordingly, while executing the step S32 of the present embodiment, the server 20 can judge if the plurality of client devices 12 or the external device 42 are located at the physical community 1 according to if the plurality pieces of address information of the plurality of client devices 12 or the external device 42 match the plurality of IP addresses assigned by the router 14 in the local area network 16. Then, whether the plurality of residents 10 or the external person 40 are able to register a client account in the server 20 using the plurality of client devices 12 or the external device 42 can be determined.

Another method is to use the router 14 to disallow the external device 42 to connect to the server 20 in the local area network 16 instead of judging by the server 20.

According to the present embodiment and the first embodiment, the plurality of residents 10 all use the plurality of client devices 12 contained in the local area network 16. Then the server 20 can use the fixed physical IP address used by the router 14 or the plurality of virtual IP addresses assigned to the plurality of client devices 12 by the router 14 to judge if the client device 12 is located at the physical community 1. When the physical community 1 has signed a contract with an Internet service provider (ISP) and built the local area network 16 in the physical community 1 via the router 14 for connecting outwards, or when all of the plurality of residents 10 in the physical community rent houses from the same landlord and the landlord provides the local area network 16 via the router 14 for connecting outwards, the methods according to the present embodiment and the first embodiment of judging the locations of the plurality of client devices 12 according to the network address information are feasible. Nonetheless, as the plurality of residents 19 in the physical community 1 have signed contracts with a plurality of ISP and the plurality of client devices 12 have respective physical IP addresses instead of containing in the same local area network 16, the judgment methods according to the present embodiment and the first embodiment are not adopted.

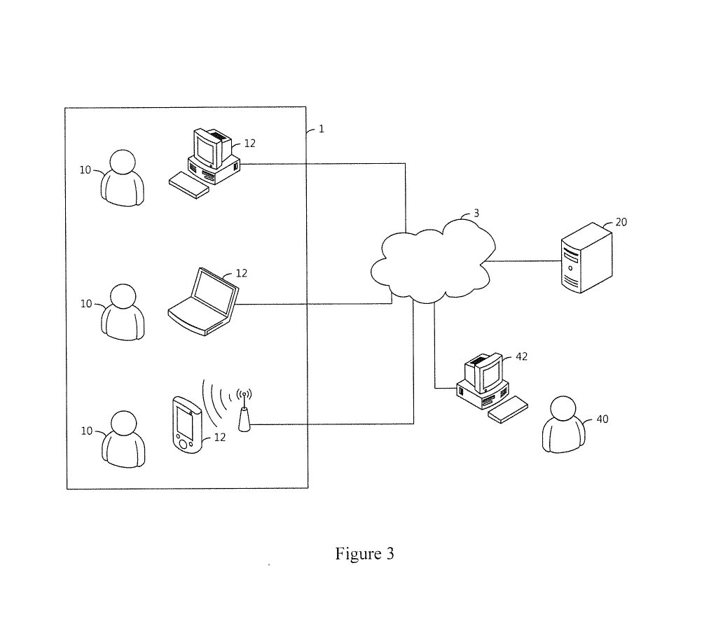

In addition to FIG. 1A, please also refer to FIG. 3, which shows a schematic diagram of the device connection according to the third embodiment of the present invention. As shown in the figure, the main difference between the present embodiment and the first one is that, instead of being contained in one local area network, the plurality of client devices 12 are connected to the Internet 3 individually. In order to enable the server 20 to judge whether the plurality of client devices 12 or the external device 42 are located at the physical community 1 according to the plurality pieces of network address information of the plurality of client devices 12 or the external device 42, the plurality of client devices 12 according to the present embodiment should use fixed physical IP addresses. The third party providing the e-commerce service platform can acquire the plurality of physical IP addresses of the plurality of client devices 12 from the plurality of residents 10. Alternatively, they can use the known physical IP segment used by the physical community 1 to record the plurality of physical IP addresses used by the plurality of client devices 12 of the physical community 1 in the server 20. Thereby, the server 20 can judge if the plurality of client devices 12 and the external device 42 are located at the physical community 1 according to the plurality pieces of network address information acquired from the plurality of client devices 12 and the external device 42. Then, whether the plurality of residents 10 or the external person 40 are permitted to use the plurality of client devices 12 or the external device 42 to register a client account in the server 20 can be thus determined.

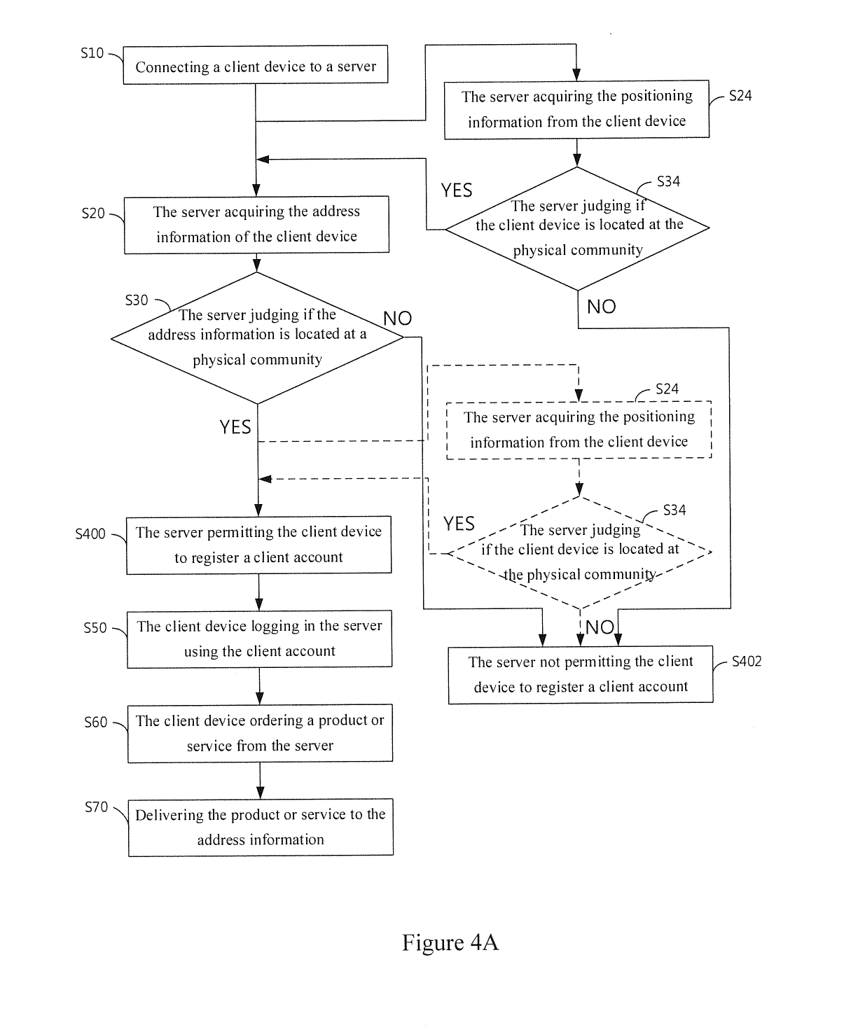

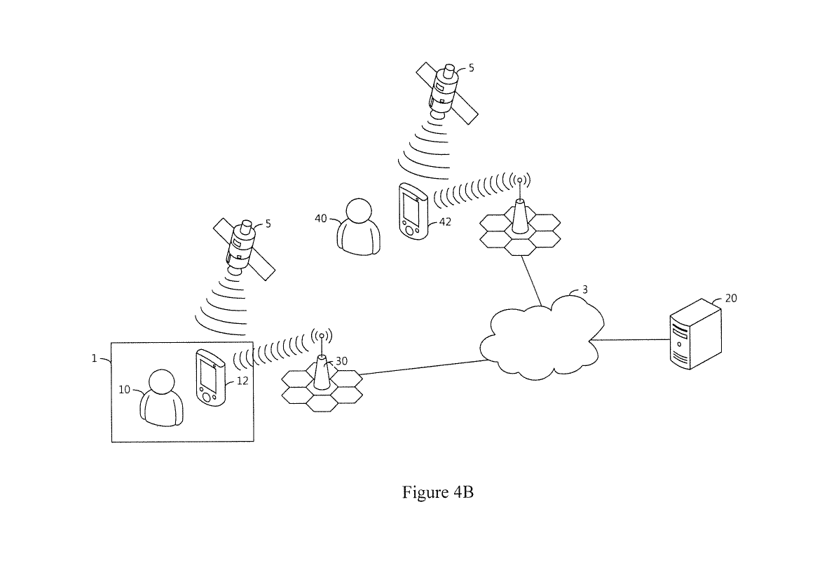

Please refer to FIG. 4A and FIG. 4B, which show a flowchart and a schematic diagram of the device connection according to the fourth embodiment of the present invention. As shown in FIG. 4A, the main difference between the method for providing e-commerce service to a physical community according to the present embodiment and the one according to the first embodiment is that according to the present embodiment, after the step S10 and before the step S20, or after the step S30 and before the step S400, the following steps are included:

Step 624: The server acquiring the positioning information from the client device; and

Step S34: The server judging if the client device located at the physical community.

As shown in FIG. 4B, a resident 10 of a physical community 1 uses a client device 12 in the physical community 1 to connect to a server 20 built with an e-commerce service platform. According to the present embodiment, the client device 12 connects to the Internet 3 via a base station 30 and to the server 20 though the Internet 3. Meanwhile, a satellite 5 positions the client device 12. In addition, an external person 40 shown in the figure uses an external device 42 to connect to the Internet 3 via another base station 30 and to the server 20 through the Internet 3. Meanwhile, another satellite 5 positions the external device 42.

In the step S24, the server 20 acquires the plurality pieces of positioning information of the client device 12 and the external device 42, respectively. As described above, the plurality of satellites 5 position the client device 12 and the client device 42 and produce the plurality pieces of positioning information.

In the step S34, the server 20 judges if the client device 12 and the external device 42 are located at the physical community 1 according to the plurality pieces of positioning information, respectively.

Because the resident 10 uses the client device 12 in the physical community 1, the position information produced by the satellite 5 by positioning the client device 12 shows that the client device 12 is located at the physical community 1. The server 20 judges that the client device 12 is located at the physical community 1. Then the following step S20 is executed, in which the client device 12 acquires the address information and judges if the resident 10 is permitted to use the client device 12 to register the client account in the server 20. Alternatively, the step S400 is executed for permitting the resident 10 to use the client device 12 to register the client account in the server 20.

Contrarily, because the external person 40 is not using the external device 42 in the physical community 1, the position information produced by the other satellite 5 by positioning the external device 42 shows that the external device 42 is located outside the physical community 1. The server 20 judges that the external device 12 is not located at the physical community 1. Then the following step S402 is executed for disallowing the external person 40 to use the external device 42 to register a client account in the server 20.

In addition to the steps S10 to S70, the steps S24 and S34 are further executed. According to the method for providing e-commerce service to a physical community of the present invention, the server 20 can judge if the client device 12 or the external device 42 is located at the physical community 1 according to the plurality pieces of positioning information of the client device 12 or the external device 42 connecting to the server 20. Then the address of the physical community 1 can be used as the address information. In addition, the plurality pieces of positioning information can be further used as the basis by which the server 20 determines if the client device 12 or the external device 42 is allowed to register a client account in the server 20. Accordingly, the purpose of limiting a plurality of registered clients of the e-commerce server platform to the plurality of residents 10 of the physical community 1 can be achieved more perfectly.

According to the present embodiment, the plurality pieces of positioning information produced by the plurality of satellites 5 by positioning the client device 12 and the external device 42 are adopted additionally as the basis for the server 20 to judge if the e-commerce service is allowed for use. If the external person 40 enters the physical community 1 and uses the external device 42, it is not identifiable that the external person 40 is actually not the resident 10 of the physical community 1. In addition, according to the first to the third embodiments, if the local area network 16 or the network provided by the plurality of ISP signed by the plurality of residents 10, respectively, contains a wireless IP router, as shown in FIG. 3, the external person 40 can also connect to the wireless IP router through the external device 42 and pass the judgment and filtering of the server 20 on the plurality of network address information acquired from the plurality of client devices 12 and the external device 42. In this case, it is not identifiable that the external person 40 is actually not the resident 10 of the physical community 1, either.

In order to improve the performance of the resident 10 of the physical community 1 using the e-commerce service provided by the server 20, after the step S10, in which the plurality of client devices 12 and the external device 42 connect to the server 20, an extra verification step of verifying information is added.

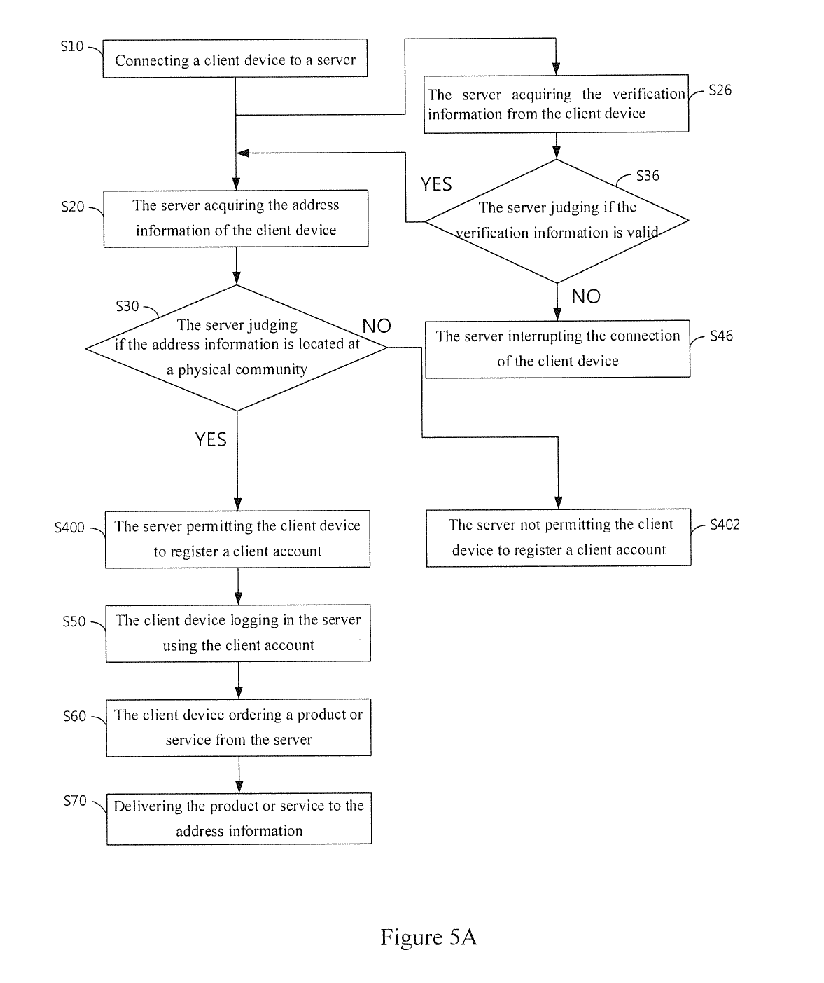

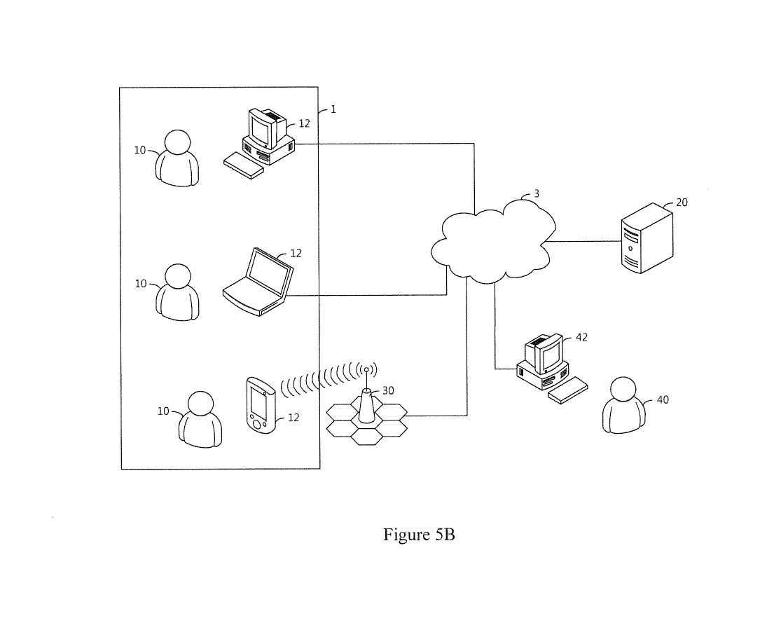

Please refer to FIG. 5A and FIG. 5B, which show a flowchart and a schematic diagram of the device connection according to the fifth embodiment of the present invention. As shown in FIG. 5A, the main difference between the method for providing e-commerce service to a physical community according to the present embodiment and the one according to the first embodiment is that according to the present embodiment, after the step S10 and before the step S20, the following steps are included:

Step S26: The server acquiring the verification information from the client device; and

Step S36: The server judging if the verification information is valid.

As shown in FIG. 5B, a physical community 1 comprises a plurality of residents 10 and a plurality of client devices 12. The plurality of residents 10 can use the plurality of client devices 12, respectively, to connect to a server 20. An e-commerce service platform is constructed in the server 20. According to the present embodiment, the plurality of client devices 12 are connected to the Internet 3. The plurality of client devices 12 can be connected to the server 20 outside the local area network 16 through the Internet 3. In particular, a client device 12 is connected to the Internet 3 via a base station 30. In addition, as shown in the figure, an external person 40 uses an external device 42 to connect to the Internet 3 and to the server 20 through the Internet 3.

Before the steps of the present invention, the third party can further provide the plurality of residents 10 with at least a piece of verification information. The verification of the verification information is configured in the server 20. Then the plurality of client devices 12 and the server 20 form a virtual private network (VPN). The verification information can be the required account and password for passing the VPN verification. Thereby, the efficacy of limiting the plurality of clients of the e-commerce service platform to the plurality of residents 10 of the physical community 1 can be enhanced.

In the step S26, the server 20 acquires a piece of verification information input by the resident 10 from the client device 12. Besides, the server 20 acquires another piece of verification information input by the external person 40 from the external device 42.

In the step S36, the server 20 verifies if the plurality pieces of verification information input by the resident 10 and the external person 40 and transmitted to the server 20 through the client device 12 and the external device 42, respectively.

Because the resident 10 lives in the physical community 1, he can get the valid verification information from the third party. Thereby, the resident 10 can transmit the valid verification information to the server 20 from the client device 12. The server 20 judges the validity of the verification information. If so, the following step S20 is executed for acquiring the address information from the client device 12 and judging if the resident 10 is permitted to register the client account in the server 20 using the client device 12.

Contrarily, because the external person 40 does not live in the physical community 1, the verification information transmitted to the server 20 by the external device 42 is invalid. The server 20 judges that the verification information is invalid. Then the following step is executed:

Step S46: The server interrupting the connection of the client device.

In the step S46, the server 20 interrupts the connection with the external device 42. Thus, the external person 40 can no longer execute the steps S20 to S70. Consequently, he will not be able to register a client account in the server 20 and use the service provided by the e-commerce service platform.

By executing the additional steps S26 and S36, according to the method for e-commerce service to a physical community of the present invention can be configured to further verify the validity of at least a piece of verification information before the server 20 receives the plurality pieces of resident information transmitted by the client device 12 and the external device 42. Thereby, the identification confirmation and limitation to the plurality of clients of the e-commerce service platform can be enhanced.

To sum up, according to the method for providing e-commerce service to a physical community of the present invention, when a client device connects to a server providing the e-commerce service, the server determines whether the client device is permitted to register a client account according to if the address information acquired from the client device is located at a physical community. After registration of client account. the client device can log in the server using the client account and order a product or service from the server. Then the product or service is delivered to the address information, and the e-commerce service provided by the server is hence restricted to the residents of the physical community. The third party who provides the platform can thus master the customer group formed by the residents of the physical community and match suppliers with the customer group fro providing products or services. The customer group formed by the residents of the physical community can reduce the costs of the suppliers on the marketing and distribution of products or services. In addition, the bargain power of the customer group can be enhanced for urging for more favorable price offerings or feedbacks. Accordingly, the trading costs of both parties can be lowered and achieving a win-win situation.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method for providing e-commerce service to a physical community, comprising steps of:
a client device connecting to a server;
said server acquiring a piece of address information from said client device;
said server permitting said client device to register a client account in said server when said address information is in a physical community;
said client device using said client account to log in said server, and ordering at least a product or service from said server; and
delivering said product or service to said address information.

2. The method for providing e-commerce service to a physical community of claim 1, and after said client device connects to said server and before said server acquires said address information from said client device, further comprising a step of said server verifying validity of a piece of verification information transmitted by said client device.

3. The method for providing e-commerce service to a physical community of claim 2, wherein said verification information includes an account and a password required for establishing a virtual private network between said client device and said server.

4. The method for providing e-commerce service to a physical community of claim 1, wherein said server further acquires a name or an identification number of a resident living at said address information from said client information.

5. The method for providing e-commerce service to a physical community of claim 1, wherein said server further acquires a piece of network address information from said client device and judges if said client device is located at said physical community according to said network address information.

6. The method for providing e-commerce service to a physical community of claim 5, wherein said network address information includes a physical Internet Protocol address or an Internet Protocol address.

7. The method for providing e-commerce service to a physical community of claim 1, wherein said client device and said server are contained in a local area network.

8. The method for providing e-commerce service to a physical community of claim 1, wherein said server further acquires a piece of positioning information from said client device and judges if said client device is located at said physical community according to said positioning information.

9. The method for providing e-commerce service to a physical community of claim 8, wherein said positioning information is given by a satellite by positioning said client device.
